(19) United States
(12) Patent Application Publication
(10) Pub. No.: US 2011/0090709 A1
(43) Pub. Date: Apr. 21, 2011

(54) ILLUMINATING DEVICE OF AN AUTOMOBILE'S TAILGATE HANDLE

(76) Inventor: Ming-Cheng WANG, Yung Kang City (TW)

(21) Appl. No.: 12/581,906

(22) Filed: Oct. 20, 2009

(51) Int. Cl. B60Q 1/26

(52) U.S. Cl. 362/501; 362/540

(57) ABSTRACT

The invention relates to an illuminating device of an automobile's tailgate handle. The illuminating device is installed in a groove formed in a tailgate handle, including a circuit board and a transparent covering. A through hole is bored in the groove. The circuit board is provided with plural LEDs and an electric wire connected with a control wire of an automobile's headlight. The transparent covering is put on the groove of the handle. Therefore, the LEDs in the handle can be lit as night warning signal if a car's headlight is turned on, as a turning signal a turning signal is turned on, or as a brake signal the brake is treaded on.

### BACKGROUND OF THE INVENTION

1. Field of the Invention

This invention relates to an illuminating device of an automobile's tailgate handle. Particularly, the tailgate handle is provided with a groove formed in a front side and a through hole bored in the groove. A circuit board is installed in the groove, provided with plural LEDs and an electric wire connected with a control wire of an automobile's headlight. A transparent covering is put on the groove of the handle. Therefore, the LEDs in the handle can be lit as a night warning signal if a car's headlight is turned on, as a turning signal if a turning signal is turned on, or as a brake signal if the brake is treaded on.

2. Description of the Prior Art

Commonly, a conventional tailgate handle of an automobile is merely employed for conveniently opening a tailgate, without any other functions such as warning illumination that is associated with headlights, brake signals or turning signals to simultaneously work with them.

### SUMMARY OF THE INVENTION

The object of this invention is to offer an illuminating device of an automobile's tailgate handle. When headlights of a car are turn on, LEDs in the tailgate handle can be simultaneously lightened as a warning signal. In addition, the LEDs can also work as an auxiliary turning signal or brake signal.

The main characteristics of the invention are a handle, a circuit board and a transparent covering. The handle is installed in a tailgate, provided with a groove and a through hole bored in the groove. The circuit board is installed in the groove, provided with plural LEDs and an electric wire to be connected with a control wire of an automobile's headlight. The transparent covering is put on the groove of the handle.

### BRIEF DESCRIPTION OF DRAWINGS

This invention is better understood by referring to the accompanying drawings, wherein:

FIG. 1 is an exploded perspective view of a preferred embodiment of an illuminating device of an automobile's tailgate handle in the present invention;

FIG. 2 is a perspective view of the preferred embodiment of an illuminating device of an automobile's tailgate handle in the present invention;

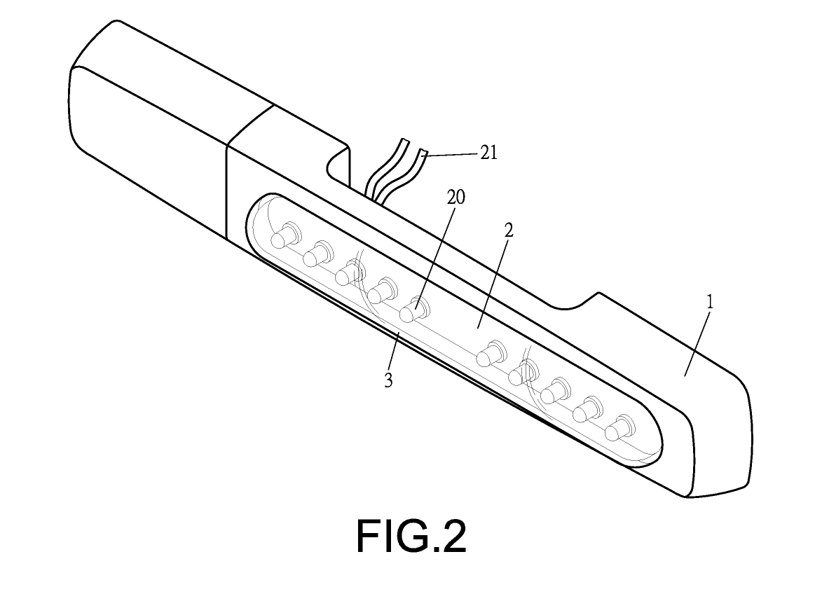

FIG. 3 is a cross-sectional view of the preferred embodiment of an illuminating device of an automobile's tailgate handle in the present invention;

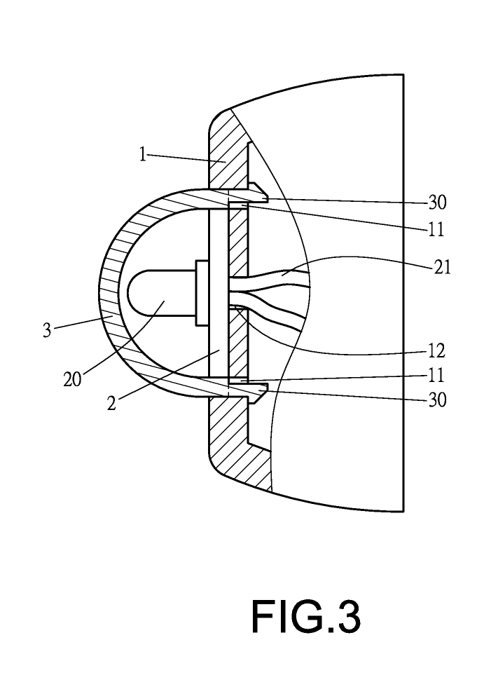

FIG. 4 is a perspective view of the preferred embodiment of an illuminating device of an automobile's tailgate handle in the present invention, showing it being installed on an automobile's tailgate; and

FIG. 5 is a flow chart of the present invention, showing how the illuminating device is controlled to work.

### DETAILED DESCRIPTION OF THE PREFERRED EMBODIMENT

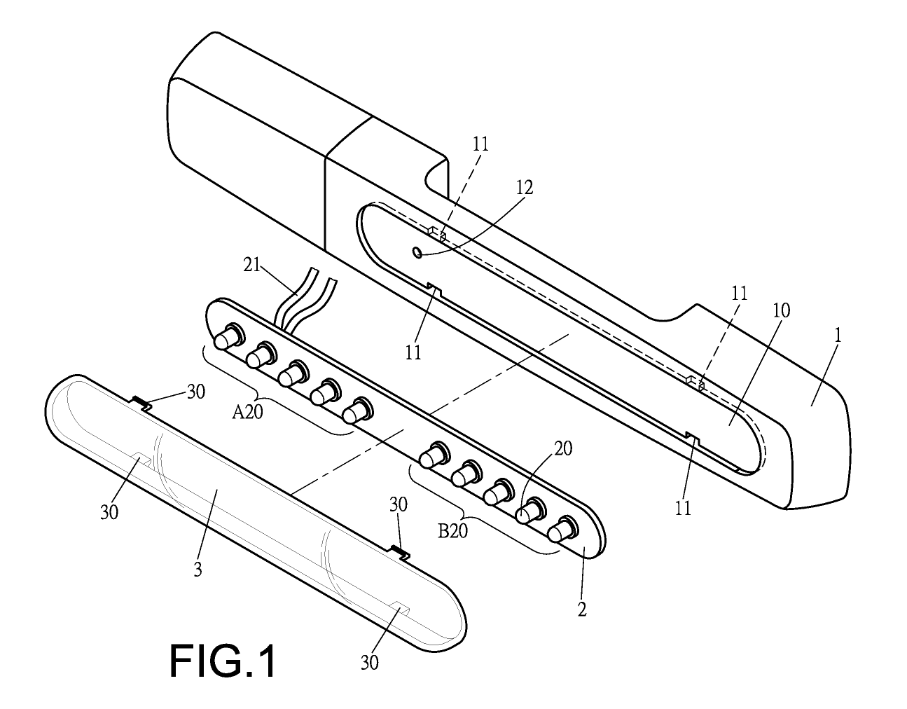

As shown in FIG. 1, a preferred embodiment of an illuminating device of an automobile's tailgate handle in the present invention includes a handle 1, a circuit board 2 and a transparent covering 3.

The handle 1 is provided with a groove 10 formed in a front side, two locking holes 11 respectively bored near two lengthwise sides of the groove 10, and a through hole 12 bored in the groove 10.

The circuit board 2 is installed in the groove 10, provided with plural LEDs 20 divided into plural left LEDs 20A and plural right LEDs 20B, and an electric wire 21 inserted through the through hole 12 to connect with a control wire of an automobile's headlight.

The transparent covering 3 is provided with two hooks 30 respectively formed at two sides to correspondingly fasten with the locking holes 11 of the handle 1.

In assembling, as shown in FIGS. 1˜3, the circuit board 2 is first put in the groove 10, with the electric wire 21 inserted through the through hole 12 of the handle 1. Then, the transparent covering 3 is put on the handle 1, with the hooks 30 correspondingly fastened with the locking holes 11 of the handle 1. Thus, the assembly of the illuminating device is finished.

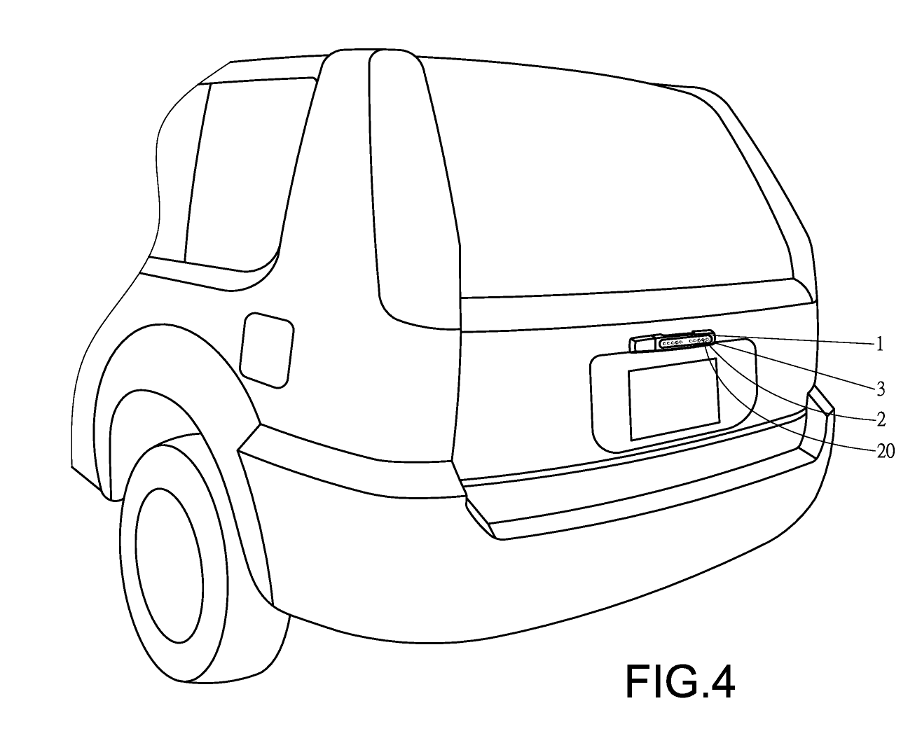

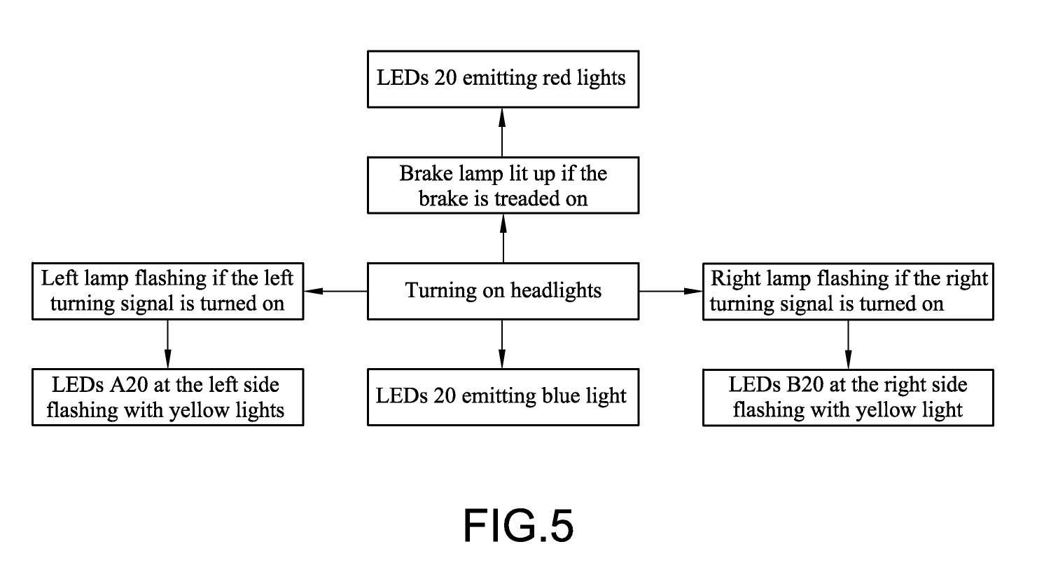

In using, as shown in FIGS. 1, 4 and 5, with the electric wire 21 of the circuit board 2 connected with the control wire of an automobile headlight, the LEDs 20 on the handle 1 can emit blue lights as night warning if the headlights are turned on, red lights as brake warning if the brake is treaded on, or yellow lights as warning to cars running behind if a turning signal is turned on. So, with the illuminating device, the handle 1 can be not only utilized for night warning, but also as an auxiliary turning signal or brake signal in addition to opening the tailgate.

While the preferred embodiment of the invention has been described above, it will be recognized and understood that various modifications may be made therein and the appended claims are intended to cover all such modifications that may fall within the spirit and scope of the invention.

What is claimed is:

1. An illuminating device of an automobile's tailgate handle comprising:
a handle provided with a groove formed in a front side, a through hole bored in said groove;
a circuit board installed in said groove and provided with plural LEDs, an electric wire connected with a control wire of an automobile's headlight; and
a transparent covering put on said groove of said handle.

2. The illuminating device of an automobile's tailgate handle as claimed in claim 1, wherein said handle is provided with two locking holes respectively bored near two lengthwise sides of said groove.

3. The illuminating device of an automobile's tailgate handle as claimed in claim 1, wherein said transparent covering is provided with two hooks respectively formed at two sides.
